(19) United States
(12) Patent Application Publication
(10) Pub. No.: US 2026/0205547 A1
(43) Pub. Date: Jul. 16, 2026

(54) INPUT DEVICE AND IMAGE FORMING APPARATUS

(71) Applicants: Ryuuta KANEDA, Kanagawa (JP); Satoshi ODANAKA, Kanagawa (JP); Hiroaki NIEDA, Kanagawa (JP); Reo KOJIMA, Kanagawa (JP); Kota SHIODERA, Tokyo (JP)

(72) Inventors: Ryuuta KANEDA, Kanagawa (JP); Satoshi ODANAKA, Kanagawa (JP); Hiroaki NIEDA, Kanagawa (JP); Reo KOJIMA, Kanagawa (JP); Kota SHIODERA, Tokyo (JP)

(21) Appl. No.: 19/419,155

(22) Filed: Dec. 15, 2025

(30) Foreign Application Priority Data
Jan. 10, 2025 (JP) 2025-004418

(51) Int. Cl. H04N 1/00; G06F 3/0488; G06F 3/0489

(52) U.S. Cl. CPC H04N 1/00411; G06F 3/0488; G06F 3/04897

(57) ABSTRACT

An input device includes a display, a touch detector, a touchless detector, and a switch. The display displays an operation screen on a display face. The touch detector detects an object that touches the display face in a touch operation. The touch operation includes a long-press touch operation in which the display face is long pressed by the object. The touchless detector detects an object, entering a detection face above the display face without touching the display face, in a touchless operation. The touchless operation includes a long-press touchless operation in which the detection face is long pressed by the object. The switch enables or disables the long-press touchless operation.

### CROSS-REFERENCE TO RELATED APPLICATIONS

This patent application is based on and claims priority pursuant to 35 U.S.C. §119(a) to Japanese Patent Application No. 2025-004418, filed on January 10, 2025, in the Japan Patent Office, the entire disclosure of which is hereby incorporated by reference herein.

### BACKGROUND

### Technical Field

### The present disclosure relates to an input device and an image forming apparatus

### Related Art

An input device in the related art includes a display that displays an operation screen, and a touchless operation detector that detects a touchless operation performed for the operation screen with a pointing body.

### SUMMARY

The present disclosure described herein provides an input device includes a display, a touch detector, a touchless detector, and a switch. The display displays an operation screen on a display face. The touch detector detects an object that touches the display face in a touch operation. The touch operation includes a long-press touch operation in which the display face is long pressed by the object. The touchless detector detects an object, entering a detection face above the display face without touching the display face, in a touchless operation. The touchless operation includes a long-press touchless operation in which the detection face is long pressed by the object. The switch enables or disables the long-press touchless operation.

The present disclosure described herein provides an image forming apparatus including the input device described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus according to an embodiment of the present disclosure;

FIG. 2 is a perspective view of an operation panel of the image forming apparatus;

FIG. 3 is a plan view of the operation panel;

FIG. 4 is a front view of the operation panel;

FIG. 5 is a functional block diagram of the operation panel;

FIGS. 6A and 6B are schematic diagrams illustrating an example of the operation panel having a configuration for switching between enabling and disabling a touchless operation corresponding to a "long press operation";

FIG. 7 is a diagram for describing a touchless operation performed when the touchless operation corresponding to the "long press operation" is enabled;

FIG. 8 is a diagram illustrating an example in which an indicator is provided that indicates whether the touchless operation corresponding to the "long press operation" is enabled or disabled; and

FIGS. 9A and 9B are diagrams illustrating an example in which a switching area is provided on a front side relative to a display.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

An input device in the related art includes a touchless operation detector. The touchless operation detector includes a light-emitting element that emits infrared rays that form an optical detection surface, and a light-receiving element that receives the infrared rays emitted from the light-emitting element. The detection surface is formed above a display surface of a display that displays an operation screen, to be parallel to the display surface. The touchless operation detector detects the entry position of an operation finger (pointing body) to the detection surface to detect a touchless operation.

With the embodiments of the present disclosure, erroneous detection of a touchless operation and execution of an operation not intended by an operator are suppressed.

An input device according to an embodiment of the present disclosure used in an operation panel of an image forming apparatus will be described below.

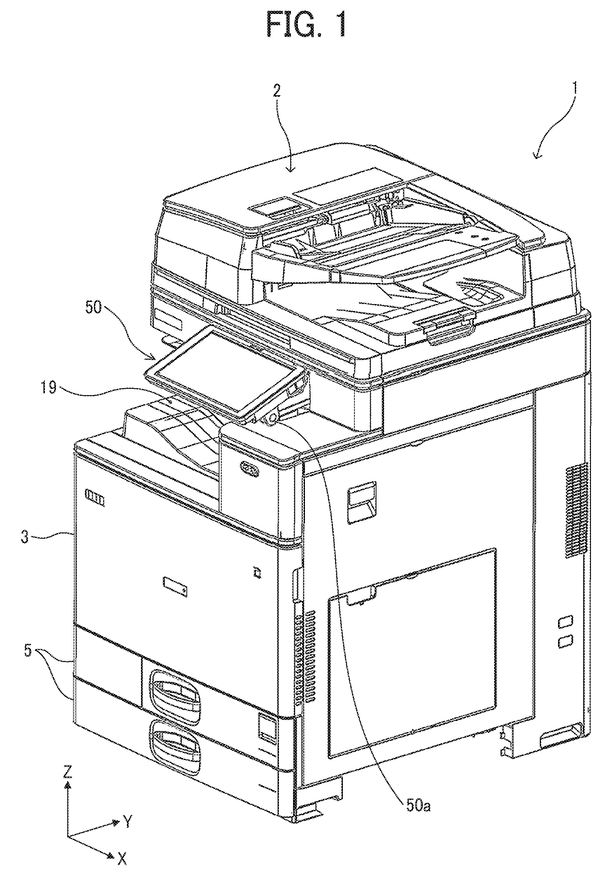

FIG. 1 is a perspective view of an image forming apparatus 1 according to the present embodiment.

The image forming apparatus 1 is a copier in which an image reading device 2 is disposed above an image forming apparatus main body 3. The image forming apparatus main body 3 includes a recording sheet accommodating section 5 and an image forming section (image formation section). The recording sheet accommodating section 5 accommodates a recording sheet that serves as a recording medium on which an image is to be formed. The image forming section serves as an image forming device.

The image forming apparatus 1 includes an operation panel 50 that is installed at a front face thereof (i.e., a face in front of a user who performs ordinary operations). The operation panel 50 is an input device that receives various input operations related to an image forming operation from the user and displays information related to the image forming operation. The operation panel 50 is rotatably supported by a support shaft 50a and thus has a variable inclination angle.

For example, the image forming section includes an exposure unit serving as an exposure device, multiple photoconductor drums, a developing device that uses toner of four colors that are cyan (C), magenta (M), yellow (Y), and black (K), a transfer belt serving as an intermediate transfer body, a secondary transfer unit, and a fixing unit. This image forming section forms an image based on print data of a read image of an original read by the image reading device 2 or print data transmitted from an external apparatus such as a personal computer (PC) in the following manner, for example. The image forming section exposes, with the exposure unit, a photoconductor drum of each color to light based on the print data to form an electrostatic latent image on each photoconductor drum. The image forming section supplies, with a developing unit of each color of the developing device, toner to the electrostatic latent image on a corresponding photoconductor drum to develop the electrostatic latent image into a toner image. The image forming section transfers the developed toner images on the respective photoconductor drums of the respective colors onto the transfer belt (i.e., primary transfer). The image forming section transfers a superimposed image of the toner images on the transfer belt, onto a recording sheet serving as a recording medium at the secondary transfer unit (i.e., secondary transfer). The image forming section applies, with the fixing unit, heat and pressure to the toner image on the recording sheet to form a color image. The recording sheet having the color image formed thereon is ejected to a sheet ejection tray 19 on the upper face of the image forming apparatus main body 3.

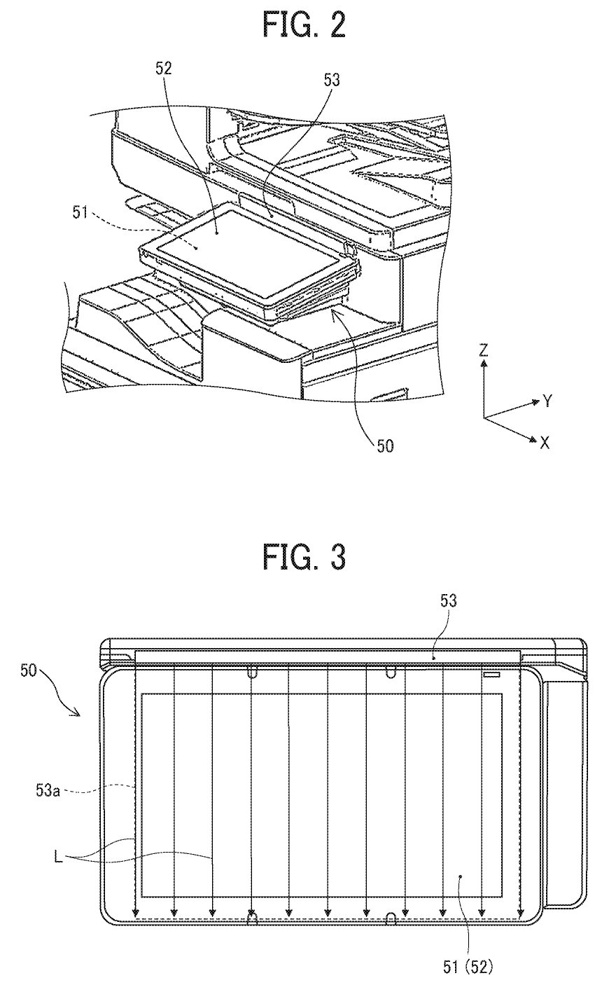

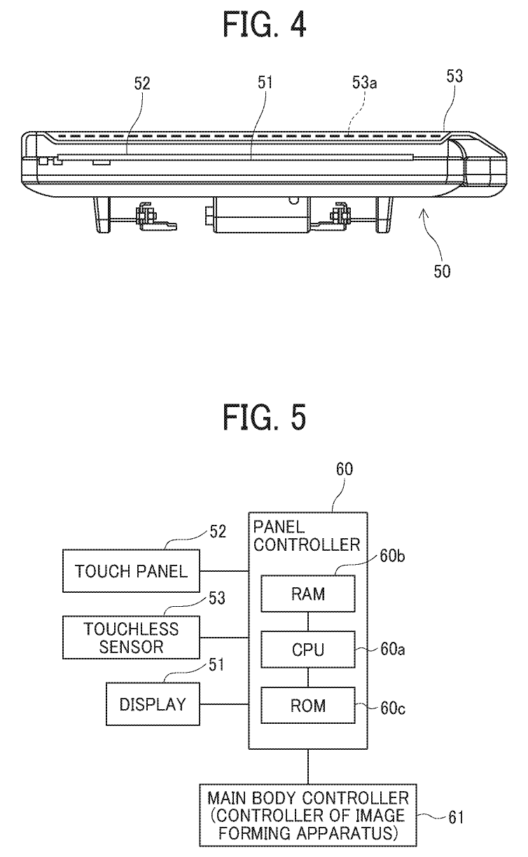

FIG. 2 is a perspective view of the operation panel 50. FIG. 3 is a plan view of the operation panel 50. FIG. 4 is a front view of the operation panel 50.

As illustrated in FIG. 2, the operation panel 50 includes a display 51 such as a liquid crystal display (LCD) or a cathode ray tube (CRT) display, a touch panel 52 serving as a touch operation detector, and a touchless sensor 53 serving as a touchless operation detector.

The touch panel 52 is a capacitive or pressure-sensitive touch sensor and is disposed to overlap the display 51. The touch panel 52 has a detection surface for detecting a touch, and detects a touched position in response to a user's finger or the like touching the detection surface.

The touchless sensor 53 is removably attached to the operation panel 50 as a touchless operation unit. Specifically, the touchless sensor 53 is attached to a portion of the operation panel 50 on the far side from the user as an optional component. The touchless sensor 53 is connected to a connection terminal such as a Universal Serial Bus (USB) terminal provided at a bottom portion of the operation panel 50 to receive power supply and communicate with a panel controller 60 (see FIG. 5, described later) that controls the operation panel 50.

As illustrated in FIGS. 3 and 4, the touchless sensor 53 includes optical units arranged in an array. The optical units each include a light-emitting element that emits an infrared ray L and a light-receiving element that receives an infrared ray. FIG. 3 schematically illustrates the infrared rays L. Actual intervals of the infrared rays L are narrower than intervals illustrated in FIG. 3.

As illustrated in FIGS. 3 and 4, a space above an operation screen of the display 51 by a predetermined distance from the operation screen serves as a detection surface 53a for detecting a touchless operation of the user for the operation screen. The user's finger enters the detection surface 53a to reflect the infrared rays L emitted by the light-emitting elements. The diffused reflected light of the infrared rays L is received by multiple light-receiving elements. Based on light intensities of the reflected infrared rays received by the respective light-receiving elements, the touchless sensor 53 detects a position of the fingertip.

In the present embodiment, the detection surface 53a is larger than the screen of the display 51. A right-side portion and a front-side portion of the detection surface 53a extend beyond the screen of the display 51 as illustrated in FIG. 3.

The touchless sensor 53 according to the present embodiment includes a one-axis scanning light path, i.e., a scanning light path of the infrared rays L emitted from the far side of the operation panel 50 in the height direction of the display 51 (i.e., a front-rear direction of the image forming apparatus 1 or a Y-direction in FIG. 2). The infrared rays reflected and diffused toward the far side of the operation panel 50 by the user's finger that has entered the detection surface 53a are received by the light-receiving elements, so that the touchless sensor 53 detects the position of the fingertip. Accordingly, it is sufficient that the touchless sensor 53 according to the present embodiment is disposed on the far side of the operation panel 50. This provides a good operability at the ends of the operation screen and does not deteriorate the appearance.

The touchless detector has a scanning light path of an infrared ray, the scanning light path extending in a front-rear direction of the input device, receives the infrared ray reflected from the object that has entered a detection surface of the touchless detector, the detection surface being for detecting the touchless operation, and detects a position of the object to detect the touchless operation performed by the object without touching the operation screen.

FIG. 5 is a functional block diagram of the operation panel 50.

As illustrated in FIG. 5, the operation panel 50 includes the panel controller 60 including a computer device such as a microcomputer. The panel controller 60 includes a central processing unit (CPU) 60a. The panel controller 60 also includes a random access memory (RAM) 60b and a read-only memory (ROM) 60c each serving as a memory connected to the CPU 60a through a bus line. The CPU 60a executes a control program, which is a preinstalled computer program, to control the display 51. The CPU 60a also executes a control program, which is a preinstalled computer program, to detect a user operation based on position information on the position detected by the touchless sensor 53 or the touch panel 52 and an operation screen displayed on the display 51. The ROM 60c stores fixed data such as a computer program and control data in advance. The RAM 60b functions as a work area or the like that stores various kinds of data in a rewritable manner.

As described above, the touch panel 52 has the detection surface for detecting a touch, and detects a touched position in response to a user's finger or the like touching the detection surface. The position information on the position detected by the touch panel 52 is sent to the panel controller 60. Based on the position information on the position detected by the touch panel 52, the panel controller 60 detects a touch operation on the operation screen displayed on the display 51.

The input device further includes an indicator (e.g., an indicator lamp 70 to be described) to indicate whether the a long-press operation is enabled or disabled.

As described above, the user's finger enters the detection surface 53a to reflect the infrared rays L emitted by the light-emitting elements. The diffused reflected light of the infrared rays L is received by the multiple light-receiving elements. Based on light intensities of the reflected infrared rays received by the respective light-receiving elements, the touchless sensor 53 detects the position of the fingertip. The position information on the position detected by the touchless sensor 53 is sent to the panel controller 60. Based on the position information on the position detected by the touchless sensor 53, the panel controller 60 detects a touchless operation for the operation screen displayed on the display 51.

Based on the detected operation performed by the user on the operation screen, the panel controller 60 identifies information related to an image forming operation input through the user operation, and sends the identified information related to the image forming operation to a main body controller 61 (i.e., a controller of the image forming apparatus).

Touch operations include a so-called "tap operation" for briefly touching the operation screen with a finger, which is a pointing body, and then separating the finger from the operation screen and a so-called "long press operation" for continuously pressing an operation target in the operation screen for a certain time. In the present embodiment, a "tap operation" on an icon image serving as the operation target displayed in the operation screen causes the execution of an operation assigned to the icon image.

On the other hand, a "long press operation" on an icon image makes the icon image draggable (movable). The user moves the finger on the operation screen while pressing the icon image to move the icon image to a desired position in the operation screen or move the icon image over another icon image for switching the positions of the icon images. The "long press operation" on an icon image causes a "×" button (i.e., a close button) to be displayed in the right corner of the icon image. Tapping the "×" button causes the icon image to be deleted from the operation screen. For example, a function of zooming in or out the operation screen in response to a "long press operation" on an area of the operation screen other than the icon images is also provided.

A touchless operation corresponding to the "tap operation" is an action of briefly placing the finger in the detection surface 53a of the touchless sensor 53 and then withdrawing the finger from the detection surface 53a. On the other hand, a touchless operation corresponding to the "long press operation" is an action of maintaining the finger at a position in the detection surface 53a of the touchless sensor 53 above the operation target displayed on the display 51 for a certain time.

However, the detection surface 53a of the touchless sensor 53 is located above the display 51 and invisible. This prevents the operator (user) from feeling the entry of the finger to the detection surface 53a and the withdrawal of the finger from the detection surface 53a.

Therefore, the operator intends to perform the touchless operation corresponding to the "tap operation" for an icon image to perform an operation corresponding to the icon image. However, the time from the entry of the finger to the detection surface 53a to the withdrawal of the finger from the detection surface 53a may exceed the certain time. Consequently, the touchless sensor 53 may detect the touchless operation corresponding to the "long press operation".

As a result, an operation corresponding to the "long press operation" is executed, that is, an operation different from the operation intended by the operator is executed.

As described above, the touchless operation corresponding to the "long press operation" is for movement or deletion of an icon image, which is an operation that is not performed during the ordinary use of the image forming apparatus 1, that is, an operation executed with a low frequency. Thus, the unfamiliar operation is abruptly executed. This bewilders some users, making the users suspicious of the failure of the image forming apparatus 1.

Extending the certain time (i.e., the time for which the finger is maintained) used for determining whether the touchless operation corresponding to the "long press operation" is performed can suppress detection of the touchless operation corresponding to the "long press operation" which is not intended by the operator. However, extending the certain time may make the operator feel uneasy about whether the finger is in the detection surface 53a during the touchless operation corresponding to the "long press operation". Consequently, the user may retry the touchless operation corresponding to the "long press operation" or become suspicious of the failure.

Accordingly, in the present embodiment, the touchless sensor 53 switches between enabling and disabling the touchless operation corresponding to the "long press operation" for an icon image displayed on the display 51. Features of the present embodiment will be described below with reference to the drawings.

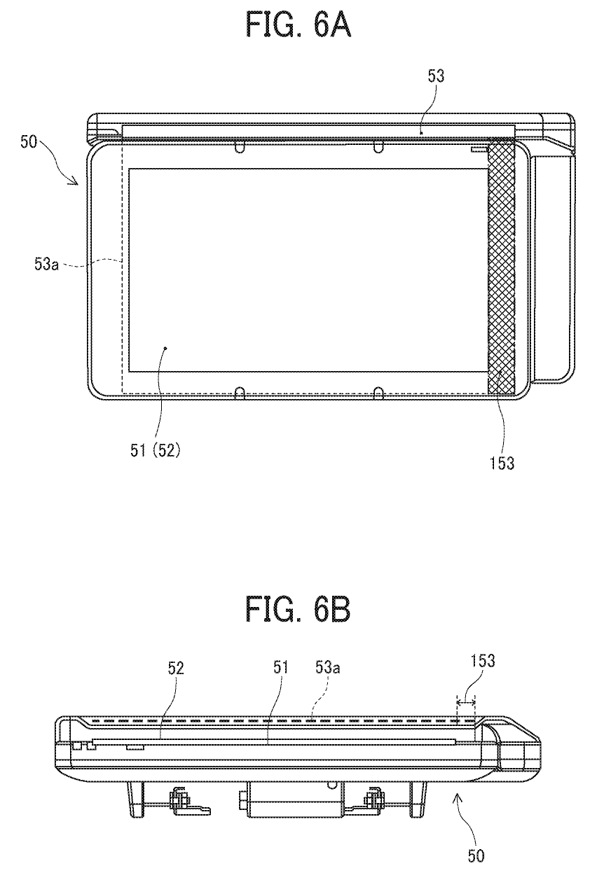

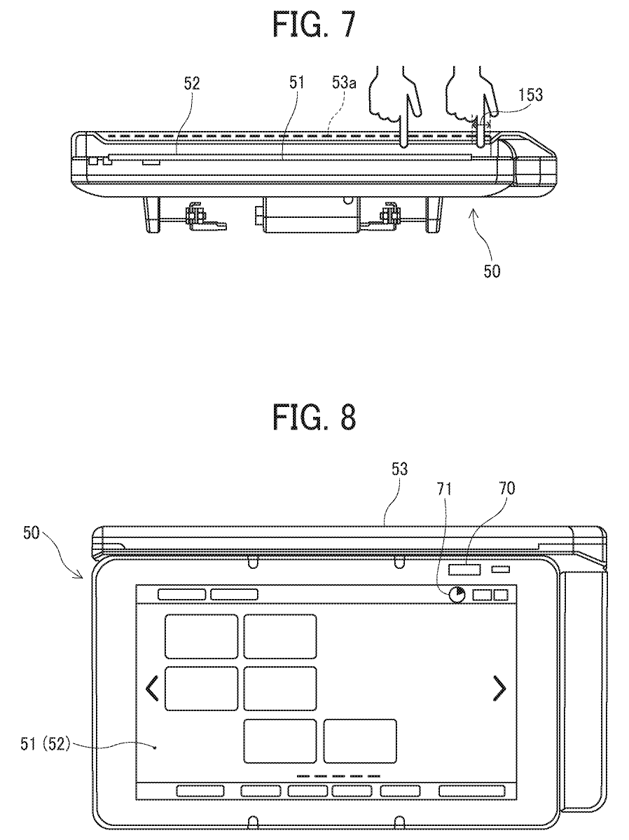

FIGS. 6A and 6B are schematic diagrams illustrating an example of the operation panel 50 having a configuration for switching between enabling and disabling the touchless operation corresponding to the "long press operation". FIG. 7 is a diagram for describing the touchless operation performed when the touchless operation corresponding to the "long press operation" is enabled.

In the present embodiment, as illustrated in FIGS. 6A and 6B, a right-side area of the detection surface 53a of the touchless sensor 53 extending beyond the screen of the display 51 is a switch area 153 serving as a switch member to switch between enabling and disabling the touchless operation corresponding to the "long press operation".

The switch region (e.g., the switch area 153) is located outside the display. This enables switching between enabling and disabling the touchless operation corresponding to the "long press operation" via a touchless operation. Unlike an operation panel equipped with a physical switch, users who prefer a touchless operation to prevent the spread of bacterial and viral infections through touches by many unspecified users are not forced to perform touch operations. The area of the detection surface 53a extending beyond the screen of the display 51 is used as the switch area 153 for switching between enabling and disabling the touchless operation corresponding to the "long press operation". Thus, part of the display resource of the display 51 is not consumed by the switch area 153.

In other words, the switch is disposed in a switch region (e.g., the switch area 153) outside the display (51) and inside a detection region of the detection face of the touchless detector (e.g., the touchless sensor 53). The touchless detector detects the object entering the detection face in the switch region.

As illustrated in FIG. 7, while the touchless sensor 53 is detecting the finger in the switch area 153, the touchless operation corresponding to the "long press operation" is enabled. On the other hand, when the touchless sensor 53 does not detect the finger in the switch area 153, the touchless operation corresponding to the "long press operation" is disabled.

In other words, the switch enables or disables the long-press touchless operation when the touchless detector (e.g., the touchless sensor 53) detects the object in the switch region (i.e., the switch area 153).

An example of the touchless operation corresponding to the "long press operation" will be described below.

When performing the touchless operation corresponding to the "long press operation", the operator enters a right finger in the switch area 153 as illustrated in FIG. 7 to enable the touchless operation corresponding to the "long press operation". While maintaining the right finger in the switch area 153, the operator enters a left finger in the detection surface 53a and points, with the left finger, to an icon image serving as the operation target in the operation screen displayed on the display 51. Consequently, the touchless operation corresponding to the "long press operation" for the icon image is detected. This makes the icon image draggable (movable) or makes the icon image deletable from the operation screen.

When the touchless operation corresponding to the "long press operation" is enabled, it is preferable to disable the touchless operation corresponding to the "tap operation". In the present embodiment, when performing the touchless operation corresponding to the "long press operation", the user enables the touchless operation corresponding to the "long press operation". Thus, even if the user's posture shifts, causing the left fingertip to briefly enter and then immediately leave the detection surface 53a when the touchless operation corresponding to the "long press operation" is enabled, the touchless operation corresponding to the "tap operation" is not detected. This can prevent an operation corresponding to the "tap operation" not intended by the user from being executed.

In other words, the touchless detector (e.g., the touchless sensor 53) detects the long-press touchless operation when the switch enables the long-press touchless operation.

The switch enables the long-press touchless operation when the touchless detector (e.g., the touchless sensor 53) detects the object in the switch region.

On the other hand, when the finger is not in the switch area 153, detection of the touchless operation corresponding to the "long press operation" is disabled. Thus, even if the time from the entry of the finger to the detection surface 53a to the withdrawal of the finger from the detection surface 53a exceeds the certain time, the touchless operation corresponding to the "long press operation" is not detected.

In other words, the input device including a display (51), the touchless detector (e.g., the touchless sensor 53), and the switch (e.g., the switch area 153). The display displays an operation screen on a display face. The touch detector (e.g., the touch panel 52) detects an object that touches the display face in a touch operation. The touch operation includes a long-press touch operation in which the display face is long pressed by the object. The touchless detector detects an object, entering a detection face (e.g., detection surface 53a) above the displace face without touching the display face, in a touchless operation. The touchless operation including a long-press touchless operation in which the detection face is long pressed by the object. The switch enables or disables the long-press touchless operation.

The touchless operation further includes a tap operation in which the object taps the detection face. The switch (e.g., the switch area 153) disables the long-press touchless operation to enable the tap operation.

In the present embodiment, the touchless operation corresponding to the "long press operation" is enabled by a both-hand operation and is disabled by a one-hand operation. This is similar to the manner of using a "shift key" or a "control key" in keyboard-based operations. An operation on the operation panel 50 is usually performed with one hand. Therefore, the touchless operation corresponding to the "long press operation" is not enabled unless the operator intends to perform the touchless operation corresponding to the "long press operation". This can prevent the operation corresponding to the "long press operation" from being executed against the intention of the operator.

The time for which the finger is maintained over the icon image for the touchless operation corresponding to the "long press operation" can be made substantially equal to the time of a touch long press operation. Thus, the operator can perform the touchless operation corresponding to the "long press operation" without feeling strange.

As illustrated in FIG. 8, the operation panel 50 may include an indicator lamp 70 that serves as an indicator to indicate to the user that the touchless operation corresponding to the "long press operation" is enabled. The indicator lamp 70 turns on when the touchless operation corresponding to the "long press operation" is enabled. This allows the user to perform the touchless operation corresponding to the "long press operation" while visually confirming that the touchless operation corresponding to the "long press operation" is enabled, and can suppress the operation mistakes. The display 51 may display an indicator icon 71 that indicates that the touchless operation corresponding to the "long press operation" is enabled.

The input device further includes an indicator (e.g., the indicator lamp 70) to indicate whether the long-press touchless operation is enabled or disabled.

Switching between enabling and disabling the touchless operation corresponding to the "long press operation" may be performed each time the touchless operation corresponding to the "tap operation" is performed in the switch area 153. Alternatively, switching between enabling and disabling the touchless operation corresponding to the "long press operation" may be performed in a similar manner of using a "Caps Lock key" in keyboard-based operations. This configuration allows the touchless operation corresponding to the "long press operation" to be performed with one hand.

In such a configuration, it is difficult to grasp whether the touchless operation corresponding to the "long press operation" is currently enabled. Thus, it is preferable to provide an indicator to indicate that the touchless operation corresponding to the "long press operation" is enabled, such as the indicator lamp 70 or the indicator icon 71, as illustrated in FIG. 8.

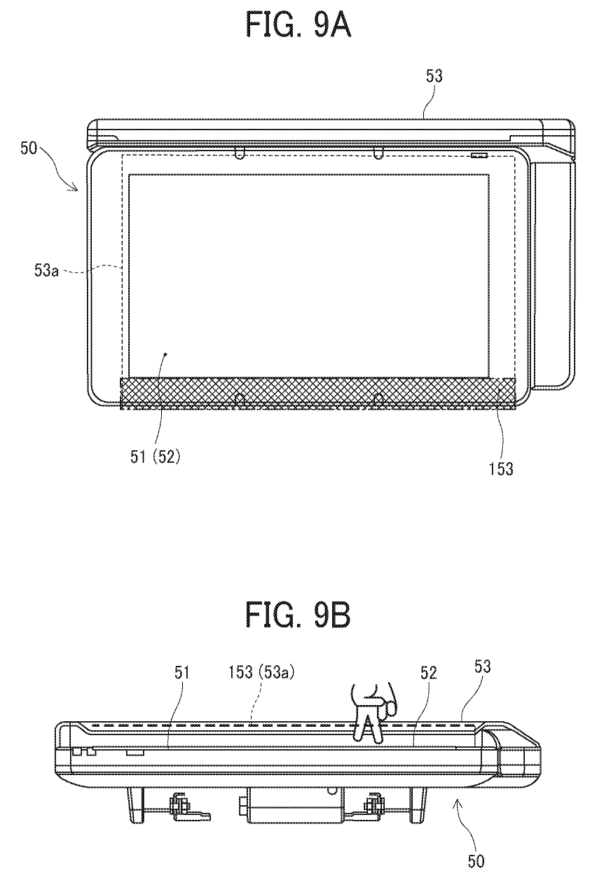

As illustrated in FIGS. 9A and 9B, an area of the detection surface 53a of the touchless sensor 53 extending beyond the front end of the screen of the display 51 (a lower area in FIG. 9A) may be set as the switch area 153 for switching between enabling and disabling the touchless operation corresponding to the "long press operation".

In the configuration illustrated in FIGS. 9A and 9B, an object such as a finger different from the finger pointing to an icon image may unintentionally enter the switch area 153, and switching between enabling and disabling the touchless operation corresponding to the "long press operation" may be unintentionally performed. Thus, it is preferable to perform switching between enabling and disabling the touchless operation corresponding to the "long press operation" in the following manner. Specifically, switching between enabling and disabling the touchless operation corresponding to the "long press operation" is performed in response to a predetermined gesture performed in the switch area 153. As illustrated in FIG. 9B, switching between enabling and disabling the touchless operation corresponding to the "long press operation" is performed in response to the entry of two fingers to the switch area 153. However, the predetermined gesture is not limited to this example. For example, switching between enabling and disabling the touchless operation corresponding to the "long press operation" may be performed in response to sliding the finger from one end to the other end of the switch area 153 in the left-right direction. As described above, switching between enabling and disabling the touchless operation corresponding to the "long press operation" is performed in response to a predetermined gesture (action) in the switch area 153. This can suppress the occurrence of unintended switching.

The switch enables the long-press touchless operation when the touchless detector (e.g., the touchless sensor 53) detects the object having a predetermined shape in the switch region.

In the present embodiment, switching between enabling and disabling the touchless operation corresponding to the "long press operation" is performed via a touchless operation. In other embodiments, the operation panel 50 may be provided with a physical switch serving as the switch member, and switching between enabling and disabling the touchless operation corresponding to the "long press operation" may be performed with the physical switch.

While preferable embodiments of the present disclosure have been described above, the present disclosure is not limited to specific embodiments and may be variously modified and altered within the scope of the spirit of the present disclosure written in the claims unless particularly limited in the description above. As described above, the touchless sensor 53 is attached as a touchless operation unit to the operation panel 50 that optionally includes the touch panel 52. In other embodiments, the operation panel 50 may include the touchless sensor 53 but does not include the touch panel 52. The input device according to the embodiments of the present disclosure is applicable to not only the image forming apparatus 1 but also to an input device of a bank automatic teller machine (ATM), an input device of a ticket machine, an input device of a cash register, an input device of an automatic checkout machine, etc.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The above description is an example, and the present disclosure exhibits specific effects according to each aspect below.

According to Aspect 1, an input device (e.g., the operation panel 50) includes a display (e.g., the display 51), a touchless operation detector (e.g., the touchless sensor 53), and a switch member (e.g., the switch area 153). The display displays an operation screen. The touchless operation detector detects a touchless operation performed for the operation screen with a pointing body (e.g., a finger). The switch member allows an operator to switch between enabling and disabling a touchless operation corresponding to a long press operation that is included in a touch operation.

Touch operations include a so-called "tap operation" for briefly touching the operation screen with a pointing body such as a finger, and then separating the pointing body from the operation screen, and a so-called "long press operation" for continuously pressing an operation target such as an icon image in the operation screen with the pointing body for a certain time. In general, the "tap operation" causes the execution of an operation assigned to the operation target such as the icon image. The "long press operation" makes the operation target draggable (movable) or makes the operation target deletable from the operation screen.

A touchless operation corresponding to the "tap operation" is an action of briefly placing the pointing body in the detection surface (e.g., the detection surface 53a) of the touchless operation detector (e.g., the touchless sensor 53) and then withdrawing the pointing body from the detection surface (e.g., the detection surface 53a). On the other hand, the touchless operation corresponding to the "long press operation" is an action of entering the pointing body to the detection surface (e.g., the detection surface 53a) and maintaining the pointing body at a position above the operation target for a certain time.

However, the detection surface (e.g., the detection surface 53a) of the touchless operation detector is invisible. This prevents the operator from feeling the entry of the pointing body (e.g., a finger) to the detection surface (e.g., the detection surface 53a) and the withdrawal of the pointing body (e.g., the finger) from the detection surface (e.g., the detection surface 53a). Therefore, the operator may actually fail to withdraw the pointing body (e.g., the finger) from the detection surface (e.g., the detection surface 53a) despite the intention to perform the touchless operation corresponding to the "tap operation". Consequently, the time from the entry of the pointing body (e.g., the finger) to the detection surface 53a to the withdrawal of the pointing body (e.g., the finger) from the detection surface 53a may exceed the certain time, and the touchless operation detector may erroneously detect the touchless operation corresponding to the "long press operation". As a result, an operation for the "long press operation" may be executed instead of an operation for the "tap operation". That is, an operation different from the operation intended by the operator may be executed.

In contrast, in Aspect 1, in a case where the touchless operation corresponding to the "tap operation" is performed, the touchless operation corresponding to the "long press operation" is disabled via the switch member. Accordingly, the touchless operation detector does not erroneously detect the touchless operation corresponding to the "long press operation" despite the operator's intention to perform the touchless operation corresponding to the "tap operation". This can suppress the execution of an operation not intended by the operator.

In a case where the touchless operation corresponding to the "long press operation" is performed, the touchless operation corresponding to the "long press operation" is enabled. This allows the operator to perform the touchless operation corresponding to the "long press operation".

According to Aspect 2, in the input device of Aspect 1, in a case where the touchless operation corresponding to the long press operation is enabled, the touchless operation detector (e.g., the touchless sensor 53) detects only the touchless operation corresponding to the long press operation.

As described in the embodiments, suppose that the operator enables the touchless operation corresponding to the "long press operation" and intends to perform the touchless operation corresponding to the "long press operation". However, the operator's posture shifts, causing the pointing body to be briefly placed in the detection surface 53a of the touchless operation detector (e.g., the touchless sensor 53) and then withdrawn from the detection surface 53a. This results in the touchless operation corresponding to the "tap operation". Even in this case, the touchless operation detector (e.g., the touchless sensor 53) does not detect the touchless operation corresponding to the "tap operation". This can suppress the execution of an operation not intended by the operator.

According to Aspect 3, in the input device of Aspect 1 or 2, the touchless operation detector (e.g., the touchless sensor 53) has a detection surface (e.g., the detection surface 53a) to detect a touchless operation, and the switch member (e.g., the switch area 153) includes a predetermined area of the detection surface (e.g., the detection surface 53a).

As described in the embodiments above, this enables switching between enabling and disabling the touchless operation corresponding to the "long press operation" via a touchless operation. Thus, switching between enabling and disabling the touchless operation corresponding to the "long press operation" can be performed without forcing a touch operation on operators who prefer a touchless operation to prevent the spread of bacterial and viral infections through touches by many unspecified operators.

According to Aspect 4, in the input device of Aspect 3, the touchless operation corresponding to the long press operation is enabled in a case where the touchless operation detector (e.g., the touchless sensor 53) detects the pointing body (e.g., the finger) in the predetermined area (e.g., the switch area 153).

Thus, as described in the embodiments, in a case where the touchless operation corresponding to the "long press operation" is performed, the pointing body is entered to the predetermined area of the detection surface 53a with one hand to enable the touchless operation corresponding to the "long press operation". In this state, the touchless operation corresponding to the "long press operation" is performed with the other hand. Thus, the touchless operation corresponding to the "long press operation" is performed in a similar manner of using a "shift key" or a "control key" in keyboard-based operations. As described above, the touchless operation corresponding to the "long press operation" is performed with both hands. That is, the touchless operation corresponding to the "long press operation" can be made different from ordinary touchless operations performed with one hand. Making the touchless operation corresponding to the "long press operation" different from ordinary touchless operations performed with one hand as described above allows the operator to intentionally perform the touchless operation corresponding to the "long press operation" and can suppress the operation mistakes.

According to Aspect 5, in the input device of Aspect 3, switching between enabling and disabling the touchless operation corresponding to the long press operation is performed each time the touchless operation detector (e.g., the touchless sensor 53) detects the pointing body (e.g., the finger) in the predetermined area (e.g., the switch area 153).

Thus, as described in the embodiments above, switching between enabling and disabling the touchless operation corresponding to the long press operation is performed in a similar manner of using a "Caps Lock key" in keyboard-based operations. This enables the touchless operation corresponding to the "long press operation" to be performed with one hand unlike Aspect 4.

According to Aspect 6, in the input device of Aspect 3, switching between enabling and disabling the touchless operation corresponding to the long press operation is performed each time the touchless operation detector (e.g., the touchless sensor 53) detects a predetermined gesture of the pointing body (e.g., the finger) in the predetermined area (e.g., the switch area 153).

As described in the embodiments above, this can prevent unintentional switching between enabling and disabling the touchless operation corresponding to the "long press operation" as a result of unintentional entry of the pointing body (e.g., the finger) to the predetermined area (e.g., the switch area 153).

According to Aspect 7, in the input device of any one of Aspects 3 to 6, the predetermined area (e.g., the switch area 153) is located outside the display (e.g., the display 51).

Thus, as described in the embodiments, the predetermined area does not occupy part of resources of the display (e.g., the display 51) and operation targets operable with a touchless operation can be arranged all over the screen of the display (e.g., the display 51) unlike the case where the predetermined area (e.g., the switch area 153) is located within the display (e.g., the display 51).

According to Aspect 8, the input device of any one of Aspects 1 to 7 includes an indicator (e.g., the indicator lamp 70). The indicator indicates whether the touchless operation corresponding to the long press operation is enabled or disabled.

As described in the embodiments, this allows the operator to perform the touchless operation corresponding to the "long press operation" while visually confirming that the touchless operation corresponding to the "long press operation" is enabled, and can suppress the operation mistakes.

According to Aspect 9, the input device of any one of Aspects 1 to 8 includes a touch operation detector (e.g., the touch panel 52). The touch operation detector detects a touch operation performed on the operation screen with the pointing body (e.g., the finger).

This allows both a touchless operation and a touch operation to be performed.

According to Aspect 10, in the input device of any one of Aspects 1 to 9, the touchless operation detector (e.g., the touchless sensor 53) has a scanning light path of an infrared ray, the scanning light path extending in a front-rear direction of the input device (e.g., the operation panel 50), receives the infrared ray reflected from the pointing body that has entered a detection surface of the touchless operation detector, the detection surface being for detecting the touchless operation, and detects a position of the pointing body to detect the touchless operation performed with the pointing body.

Thus, it is sufficient that the touchless operation detector (e.g., the touchless sensor 53) is installed on one side in the front-rear direction of the display surface. This can suppress the deterioration of the operability and the appearance by the touchless operation detector.

According to Aspect 11, an image forming apparatus (e.g., the image forming apparatus 1) includes an input device (e.g., the operation panel 50). The input device is the input device according to any one of Aspects 1 to 10.

This can suppress the execution of an operation not intended by the operator in response to a touchless operation.

1. An input device comprising:
a display to display an operation screen on a display face;
a touch detector to detect an object that touches the display face in a touch operation,
the touch operation including a long-press touch operation in which the display face is long pressed by the object; and
a touchless detector to detect an object, entering a detection face above the display face without touching the display face, in a touchless operation,
the touchless operation including a long-press touchless operation in which the detection face is long pressed by the object; and
a switch to enable or disable the long-press touchless operation.

2. The input device according to claim 1, wherein:
the touchless operation further includes a tap operation in which the object taps the detection face, and
the switch disables the long-press touchless operation to enable the tap operation.

3. The input device according to claim 1, wherein:
the touchless detector detects the long-press touchless operation when the switch enables the long-press touchless operation.

4. The input device according to claim 1, wherein:
the switch is disposed in a switch region outside the display and inside a detection region of the detection face of the touchless detector, and
the touchless detector detects the object entering the detection face in the switch region.

5. The input device according to claim 4, wherein:
the switch enables the long-press touchless operation when the touchless detector detects the object in the switch region.

6. The input device according to claim 4, wherein:
the switch enables or disables the long-press touchless operation when the touchless detector detects the object in the switch region.

7. The input device according to claim 4, wherein:
the switch enables the long-press touchless operation when the touchless detector detects the object having a predetermined shape in the switch region.

8. The input device according to claim 4, wherein:
the switch region is located outside the display.

9. The input device according to claim 1, further comprising:
an indicator to indicate whether the long-press operation is enabled or disabled.

10. The input device according to claim 1, wherein:
the touchless detector:
has a scanning light path of an infrared ray, the scanning light path extending in a front-rear direction of the input device;
receives the infrared ray reflected from the object entering the detection face of the touchless detector; and
detects a position of the object,
to detect the touchless operation.

11. An image forming apparatus comprising:
the input device according to claim 1.
